(19) United States
(12) Patent Application Publication
(10) Pub. No.: US 2014/0157531 A1
(43) Pub. Date: Jun. 12, 2014

(54) Split Wiper Assembly for UV Disinfection Modules

(71) Applicant: Ozonia North America, LLC, Leonia, NJ (US)

(72) Inventors: Bruno Ferran, Bloomfield, NJ (US); Robert Molter, Flanders, NJ (US); Manileo Lapugot, Bloomfield, NJ (US)

(73) Assignee: Ozonia North America, LLC, Leonia, NJ (US)

(21) Appl. No.: 13/712,860

(22) Filed: Dec. 12, 2012

(51) Int. Cl. B08B 7/00

(52) U.S. Cl. CPC B08B 7/0035
USPC 15/4

(57) ABSTRACT

The present invention is directed to a cleaning system for a UV disinfection module. In general, the UV disinfection module may have a pair of headers with a multiplicity of UV lamps extending therebetween. The cleaning system may include a cleaning plate having a multiplicity of openings therein, the openings arranged to substantially coincide with positions of the lamps to permit movement of the plate between the headers; a split wiper assembly including a plurality of wiper portions, each wiper portion mounted in a housing, the split wiper assembly connected to the cleaning plate and substantially encircling each opening, sized such that each split wiper assembly has an inner diameter less than the exterior diameter of a corresponding lamp; and a movement device operatively connected to move the plate between the headers.

### BACKGROUND OF THE INVENTION

The present invention is generally directed to a cleaning system for ultraviolet (UV) disinfection modules. More specifically, the present invention is directed to a split wiper or brush, with associated housing, that permits cleaning systems to be quickly and efficiently replaced or adapted to specific treatment conditions.

Utilization of UV for disinfection of potable and wastewater increases on an ongoing basis. A number of UV disinfection systems are commercially available and utilized for a wide variety of wastewater and potable disinfection process.

In general, UV light is a portion of the electromagnetic spectrum that has many uses. For example, UV light can be used in a purification or disinfection system to kill bacteria and break down chemicals in a fluid, such as water or air. UV light can also be used to cause chemical reactions in order to break down certain chemicals and make certain chemical compounds.

In order to harness this ability of UV light, a UV reactor may be utilized. In general, a UV reactor may comprise one or more UV lights, often made from a straight hollow tube of UV transparent material, such as quartz. This tube is filled with a gas such that when an electric current passes through the gas, ultraviolet light is produced. Such UV lamps are often placed in a secondary jacket of UV transparent material, again, such as quartz. The jacket may keep water or wastewater away from the lamp. The lamp and jacket may be referred to as a reactor tube.

One or more reactor tubes may be placed in a disinfection module so that the water or wastewater flows through and/or around the reactor tubes. However, it has been an ongoing problem in the field of UV disinfection that, over the course of time, the quartz jackets surrounding the individual UV lamps tend to foul due to the slow build-up or accumulation of deposited material on the quartz jackets. Such materials include particulates, fats, oils, greases and the like that are typical of foreign matter contained with the water being disinfected. A number of systems and processes have been developed to remove such accumulations and/or deposits. Such systems include various reciprocating wiper systems which tend to have one problem or another in effectively and economically achieving the task of cleaning quartz jackets for an extended period of time.

As fouling and scale accumulate on the outer jackets, it increasingly blocks the UV light, thereby reducing the effectiveness of the disinfection module. However, oftentimes, due to the arrangement of multiple reactor tubes, the task of cleaning the jackets is difficult without partially dismantling the disinfection module. This issue has been addressed in the art in various ways, for example by U.S. Pat. No. 6,649,917, owned by Infilco Degremont, Inc., and incorporated herein by reference in its entirety.

Broadly speaking, U.S. Pat. No. 6,649,917 teaches utilizing a cleaning plate with a multiplicity of holes, and associated wipers. The cleaning plate traverses between two headers along the path of the reactor tubes, and with the reactor tubes traveling through the holes and associated wipers on the cleaning plate. However, issues with the gradual decreasing effectiveness of the wipers or brushes that encircle the reactor tubes may be present. In addition, depending on specific water and/or wastewater conditions, the type of cleaning implement (e.g., a solid wiper or a brush) may vary.

Changing the wipers or brushes may be a time and manpower intensive task, as a header may need to be removed to slide the cleaning plate and wipers off of the multiplicity of lamps, replace the wipers, and slide the entire unit back on. Such time and manpower requirements reduce the ability to quickly and efficiently change the cleaning implement if the water and/or wastewater conditions change.

Accordingly, it is desirable to provide a cleaning system for a UV disinfection module that can quickly and efficiently be changed in order to allow for quick and efficient routine maintenance or adaptation to existing or changing water or wastewater conditions.

### SUMMARY OF THE INVENTION

Aspects of some embodiments of the present invention may include a cleaning system for a UV disinfection module having a pair of headers with a multiplicity of UV lamps extending therebetween comprising: a cleaning plate having a multiplicity of openings therein, the openings arranged to substantially coincide with positions of the lamps to permit movement of the plate between the headers; a split wiper assembly comprising a plurality of wiper portions, each wiper portion mounted in a housing, the split wiper assembly connected to the cleaning plate and substantially encircling each opening, sized such that each split wiper assembly has an inner diameter less than the exterior diameter of a corresponding lamp; and a movement device operatively connected to move the plate between the headers.

Aspects of some embodiments of the present invention may include a cleaning system for a UV disinfection module having a pair of headers with a multiplicity of UV lamps extending therebetween comprising: a cleaning plate having a multiplicity of openings therein, the openings arranged to substantially coincide with positions of the lamps to permit movement of the plate between the headers; a split wiper assembly comprising a plurality of wiper portions that overlap each other in order to fully encircle each opening, each wiper portion mounted in a housing the split wiper assembly connected to the cleaning plate and substantially encircling each opening, sized such that each split wiper assembly has an inner diameter less than the exterior diameter of a corresponding lamp; the split wiper assembly being held in position by one or more mounting plates comprising a first surface and a second surface and wherein the first surface is in contact with the split wiper assembly and the second surface is in contact with the cleaning plate, thereby sandwiching the split wiper assembly between the first surface and the cleaning plate; and a movement device operatively connected to move the plate between the headers.

Still other aspects of some embodiments of the present invention may include a cleaning system for a UV disinfection module having a pair of headers with a multiplicity of UV lamps extending therebetween comprising: a cleaning plate having a multiplicity of openings therein, the openings arranged to substantially coincide with positions of the lamps to permit movement of the plate between the headers; a split wiper assembly comprising a plurality of wiper portions that overlap each other in order to fully encircle each opening, each wiper portion mounted in a housing the split wiper assembly connected to the cleaning plate and substantially encircling each opening, sized such that each split wiper assembly has an inner diameter less than the exterior diameter of a corresponding lamp; the split wiper assembly being held in position by one or more mounting plates comprising a first surface and a second surface and wherein the first surface is in contact with the split wiper assembly and the second surface is in contact with the cleaning plate, thereby sandwiching the split wiper assembly between the first surface and the cleaning plate; and a rotatable screw operatively connected to move the cleaning plate between the headers.

Note that other aspects will become apparent from the following description of the invention taken in conjunction with the following drawings, although variations and modifications may be effected without departing from the spirit and scope of the novel concepts of the invention.

### BRIEF DESCRIPTION OF THE DRAWING

The present invention can be more fully understood by reading the following detailed description together with the accompanying drawings, in which like reference indicators are used to designate like elements. The accompanying figures depict certain illustrative embodiments and may aid in understanding the following detailed description. Before any embodiment of the invention is explained in detail, it is to be understood that the invention is not limited in its application to the details of construction and the arrangements of components set forth in the following description or illustrated in the drawings. The embodiments depicted are to be understood as exemplary and in no way limiting of the overall scope of the invention. Also, it is to be understood that the phraseology and terminology used herein is for the purpose of description and should not be regarded as limiting. The detailed description will make reference to the following figures, in which:

FIG. 1 illustrates a top view of a UV disinfection module, as known in the prior art.

FIG. 2 depicts an exemplary cleaning plate, used to clean the reactor tubes in a UV disinfection module, as known in the prior art.

FIG. 3 illustrates a split wiper design, including the split housing, in accordance with some embodiments of the present invention.

FIG. 4 illustrates a split wiper and a split brush design, including associated split housings, in accordance with some embodiments of the present invention.

FIG. 5 illustrates a reactor tube with a split wiper assembly, in accordance with some embodiments of the present invention.

FIG. 6 illustrates a reactor tube with a split wiper and a split brush assembly, in accordance with some embodiments of the present invention.

FIG. 7 illustrates a cross section of a split wiper assembly, showing the attachment of the assembly to the cleaning plate, in accordance with some embodiments of the present invention.

FIG. 8 depicts a cleaning plate mounted in a UV disinfection module, in accordance with some embodiments of the present invention.

Before any embodiment of the invention is explained in detail, it is to be understood that the present invention is not limited in its application to the details of construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION OF THE INVENTION

The matters exemplified in this description are provided to assist in a comprehensive understanding of various exemplary embodiments disclosed with reference to the accompanying figures. Accordingly, those of ordinary skill in the art will recognize that various changes and modifications of the exemplary embodiments described herein can be made without departing from the spirit and scope of the claimed invention. Descriptions of well-known functions and constructions are omitted for clarity and conciseness. Moreover, as used herein, the singular may be interpreted in the plural, and alternately, any term in the plural may be interpreted to be in the singular.

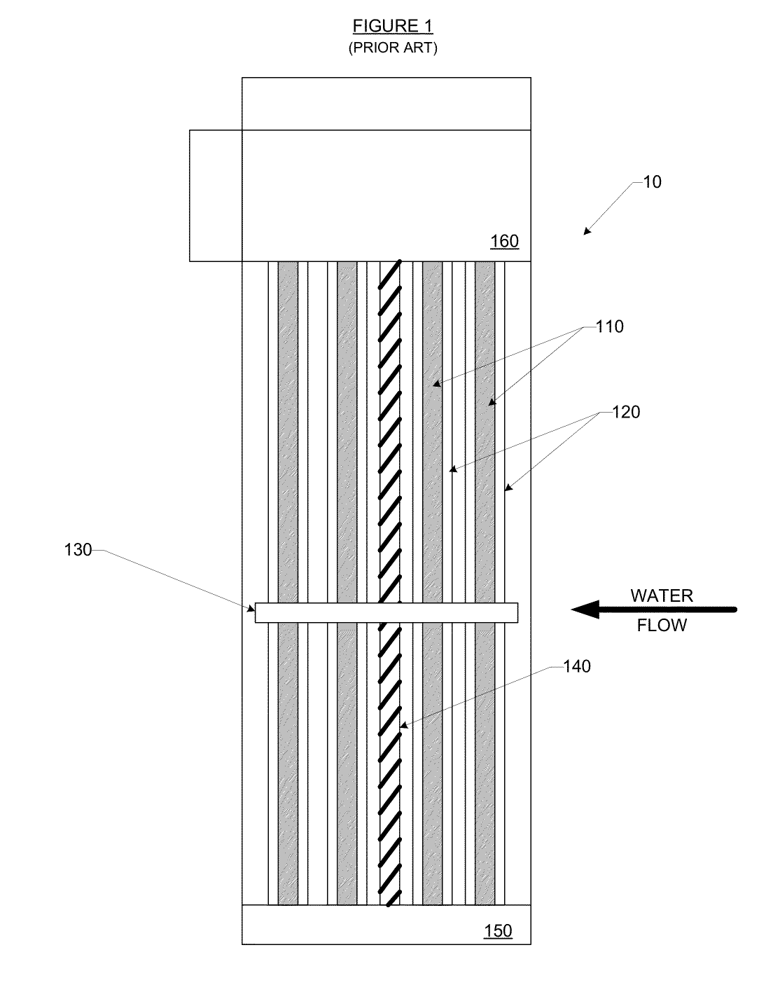

With reference to FIG. 1, an ultraviolet disinfection module 10, as may be known in the prior art will be discussed. UV disinfection module 10 may comprise, among other components, one or more UV lamps 110 that may extend between two headers 150, 160. The lamps 110 may be positioned within a transparent jacket 120, which may be made from UV transparent or resistant materials, such as but not limited to quartz.

In operation, water or wastewater (or any fluid to be treated, including air or other gases) may travel through the UV lamps 110. For example, the water or wastewater may travel in a direction parallel to that of the cleaning plate 130 and therefore pass around and/or between the one or more UV lamps 110. As the water or wastewater passes around and/or between the one or more UV lamps 110, the UV light emitted by the lamps 110 may disinfect or otherwise treat the water or wastewater.

In addition, the UV disinfection module 10 may comprise a cleaning plate 130. A movement device 140—for example, a threaded rod or screw, a hydraulic piston, an electric or fluid motor, magnetic, a chain drive or other rotary device, etc. may also be present. The movement device 140 may be disposed such that it can effectuate movement of the cleaning plate 130 from one header 150 to the other header 160. Note that the cleaning plate 150 may or may not contact each header 150, 160, but rather may travel substantially between the two.

The Cleaning plate 130 may include a number of holes or orifices aligned with the UV lamps 110 and jackets 120, such that as the cleaning plate 130 travels between the headers 150, 160, the UV lamps 110 and jackets 120 pass through the holes or orifices.

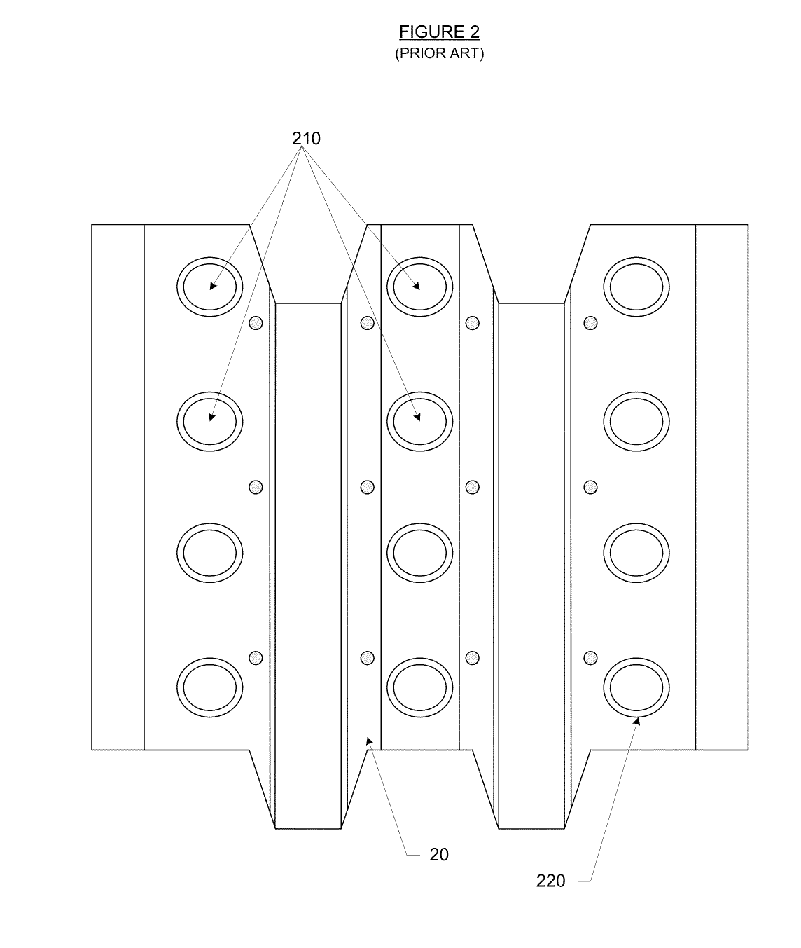

With reference to FIG. 2, a cleaning plate 20 as may be generally known in the prior art is depicted. Cleaning plate 20 may comprise a plate surface with one or more holes or orifices 210 therein. As noted above with regard to FIG. 1, these holes or orifices 210 may be positioned to align with the UV lamps and jackets utilized by the UV disinfection module. In addition, the cleaning plate 20 may comprise a cleaning apparatus 220 that encircles or surrounds each hole or orifice 210. The cleaning apparatus 220 may comprise a wiper, a brush, a squeegee, or any other type of cleaning device. The cleaning apparatus 220 may remove build-up and scale present on the lamps and/or jackets through either mechanical contact (e.g., scrubbing, rubbing, or scraping, etc.), or by other means as may be known in the art. In order to provide effective cleaning, the cleaning apparatus 220 generally encircles or surrounds each hole or orifice 210 so that each portion of the UV lamp or jacket is cleaned. In addition, the cleaning apparatus 220 may be sized such that the mechanical interaction between the cleaning apparatus 220 and the UV lamp or jacket is proper to ensure proper cleaning For example, if the cleaning apparatus 220 is a rubber wiper, the rubber wiper 220 will be sized such that as the cleaning plate 20 passes between each header (as discussed above), the rubber wiper 220 will be in sufficient contact with the UV lamp or jacket to effectuate cleaning If the cleaning apparatus 220 is a bristle brush, for example, the sizing of the cleaning apparatus 220 around the hole or orifice 210 may vary.

As noted above, such prior art systems have several drawbacks and disadvantages. For example, it can be very difficult and time consuming to replace the cleaning apparatus 220. Cleaning apparatus 220 may be replaced after wear and erosion of the cleaning apparatus 220 reduces its effectiveness, or may be replaced in order to adapt the cleaning apparatus 220 to the specific conditions of the water or wastewater the UV disinfection unit is treating. For example, the characteristics of some water or wastewater may result in scale accumulating on the UV lamps and jackets, which may require a stiff rubber wiper for removal. The characteristics of other water or wastewater treated may result in a layer of sludge or film accumulating on the UV lamps and jackets, which may require a bristle brush for removal.

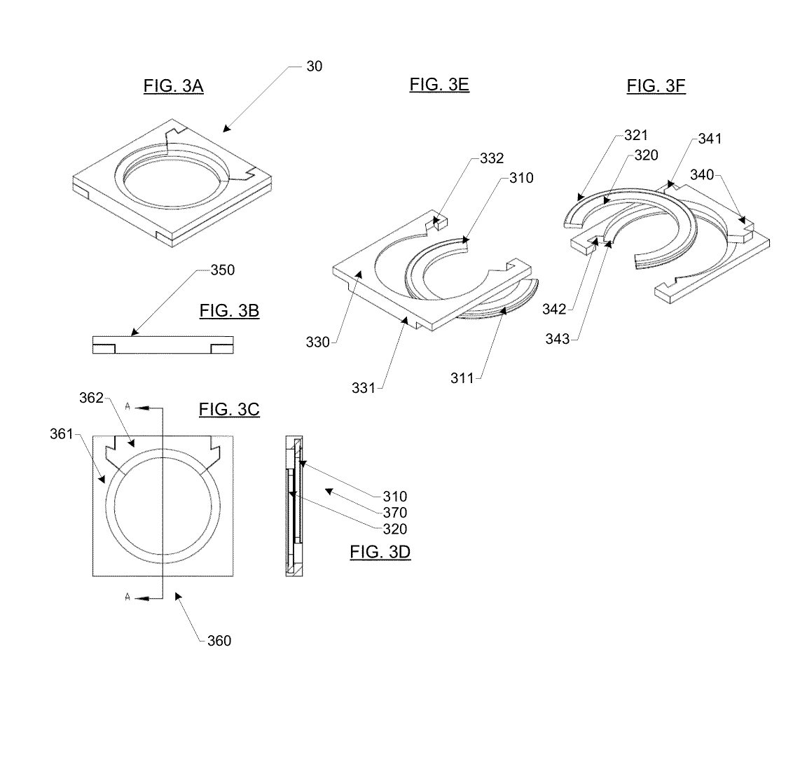

Therefore, in accordance with some embodiments of the present invention, a cleaning device that is split into at least two (2) components will now be discussed. With reference to FIG. 3 a split wiper assembly 30 is illustrated. Note that while a split wiper is discussed, the same discussion below may apply to any type of cleaning apparatus—for example a split brush, squeegee, etc. Split wiper assembly 30 may comprise at least two (2) wiper portions 310, 320 with associated housings 330, 340. Each wiper portion may surround a portion of the UV lamp or jacket such that when assembled the split wiper assembly 30 may surround the entirety of the circumference of the UV lamp or jacket. Note that while two (2) portions are illustrated, it is contemplated that the present invention may be adapted to support any number of portions.

It may be important to maintain uniform friction around the circumference of the UV lamp or jacket. If the friction is greater on one side than the other, the resulting moment may cause the cleaning plate to become askew, which may jam the cleaning plate on the UV lamps or jackets between the headers. In order to maintain such uniform friction, and in accordance with some embodiments of the present invention, the split wiper portions 310, 320 may each surround more than 180 degrees, thereby providing overlap of coverage. In addition, in order to provide uniform friction—and uniform coverage—the split wiper portions 310, 320 may be inserted into split housing components 330, 340.

The split housing components 330, 340 may be designed such that the housing components 330, 340 may fit together into a single assembly 30. For example, a first housing component 330 may comprise an extruded portion 331 that may align with the opening in the second housing component 340. Similarly, the second housing component 340 may comprise an extruded portion that may align with the opening in the first housing component 330. In order to provide a secure attachment, it is contemplated that the housing portions 330, 340 may be keyed to mate with each other. For example, the first housing portion 330 may comprise an opening 332 sized and located such that, upon assembly, a raised portion 341 of the second housing component may fit within the opening.

A side view of the assembled split wiper assembly 350 illustrates how the two wiper and housing portions interlock together. Top view of the assembly 360 illustrates the same. Note how the raised portion from one of the housing components 362 mates with the housing 361 of the other portion. With reference to cross-section A-A—depicted in assembly 370—the overlapping portions of the wipers 310 and 320 can be seen.

In accordance with some embodiments of the present invention, it is also contemplated that the split wiper portions 310, 320 may comprise a lip or ridge 311, 321 on the wiper portion that may align with a recess (for example, recess 343 in the second housing portion) in the housing portions 330, 340. Such design may provide for additional securement of the split wiper portions.

Moreover, the recess 343 that receives the wiper portion may have an inside diameter slightly smaller than the outside diameter of the wiper portion. Accordingly, even as the wipers wear and tear, friction force between the wiper assembly and the UV lamps or jackets may be maintained—or at least maintained above a minimum value, thereby increasing the useful lifetime of the wiper.

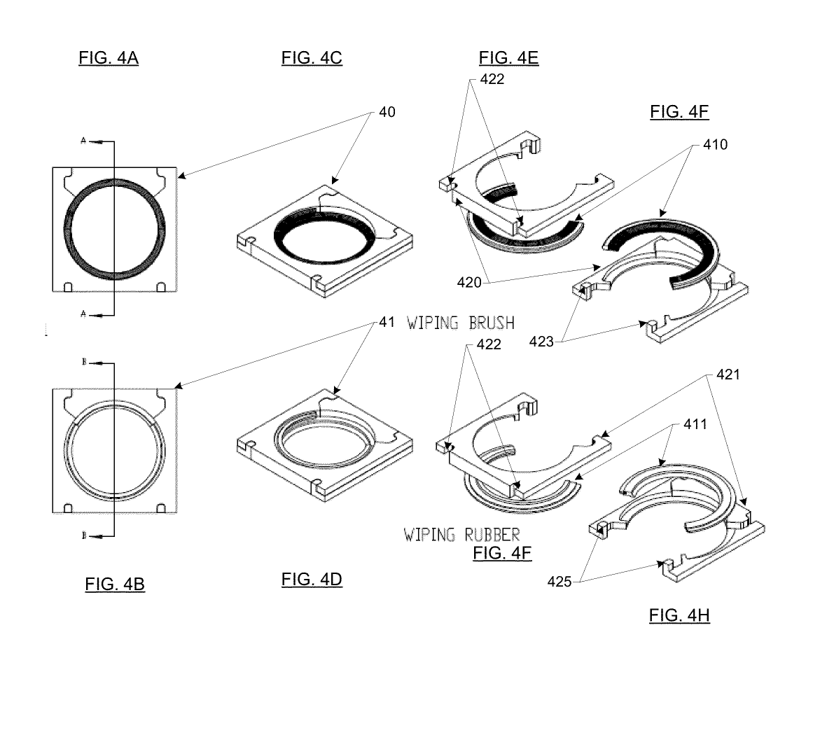

With reference to FIG. 4, some embodiments of the present invention may be utilized for both wiping rubber components and wiping brush components. Wiping brush assembly 40 may comprise at least two wiping brush portions 410 and associated housing 420. Wiping rubber assembly 41 may comprise at least two wiping rubber portions 411 and associated housings 421.

Note that FIG. 4 illustrates a slightly different housing design which comprises an post-type protrusion 423, 425 in each housing portion that inserts into opening 422, 424 in the opposite housing. Again, having the housings keyed together may provide for additional security and support of the cleaning portions.

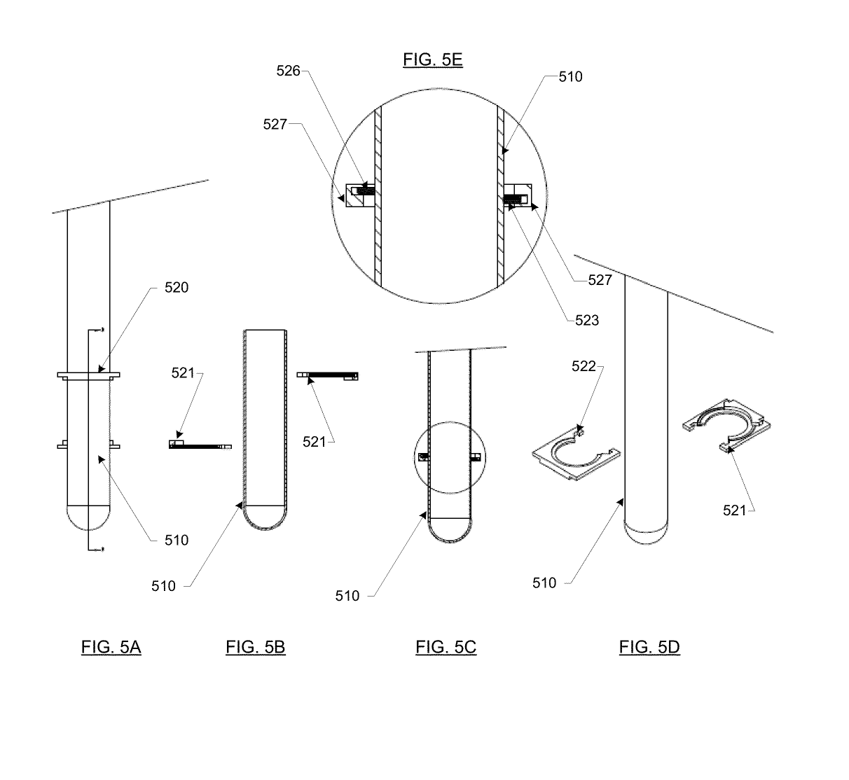

With reference to FIG. 5, the interaction between a split assembly and the UV lamp or jacket will now be discussed. As noted above, the cleaning apparatus may contact the UV lamp or a jacket. Generally speaking, a jacket is utilized (in order to protect the UV lamp, as well as provide an easier means for changing UV lamps without disassembling the entire module). Accordingly, the discussion below discusses the cleaning apparatus contacting a jacket. Note however, that the same arrangement can be used with the cleaning apparatus contacting the lamp directly.

FIG. 5 depicts jackets 510, surrounded by a split wiper assembly 520. As shown in both cross section B-B and the isometric view, the split wiper assembly 520 may comprise two wiper portions and associated housings 521, 522. The wiper portions and associated housings 521, 522 may be assembled around the jacket 510 (that is, with the jacket in place), or may be assembled and the jacket then introduced between the portions, by for example, moving the cleaning plate along the length of the jacket.

With continued reference to FIG. 5, the detail view shows two wiper portions 523 and 526, each surrounding just over 180 degrees of the jacket. Each wiper portion is supported by a housing—wiper portion 523 is supported by housing 524; wiper portion 526 is supported by housing 527.

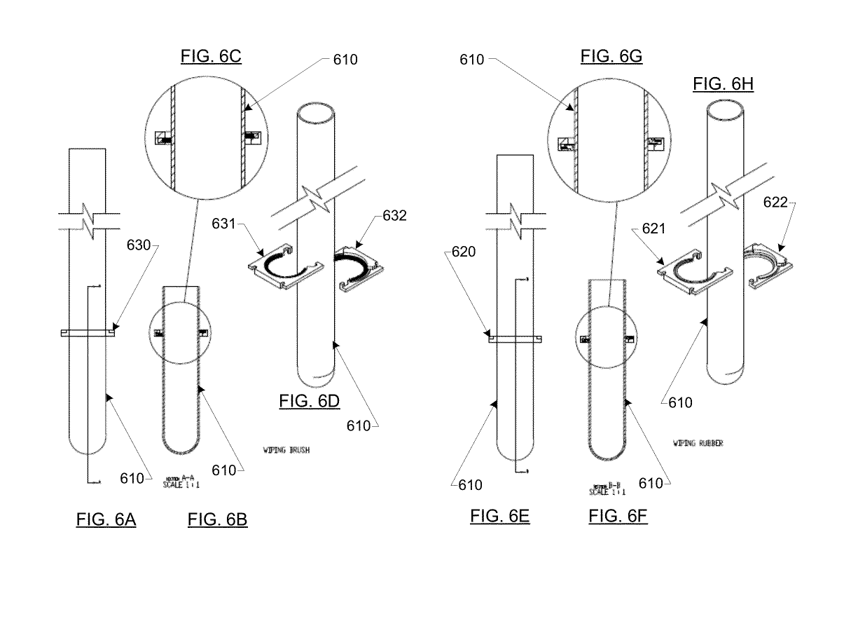

FIG. 6 illustrates, that in accordance with some embodiments of the present invention, a split wiping brush or wiping rubber may be used. Jacket 610 may be surrounded by a wiping brush assembly 630, comprising at least two wiping brush portions with associated housing 631, 632. Jacket 610 may also be surrounded by a wiping rubber assembly 620, comprising at least two wiping rubber portions with associated housings 621, 622.

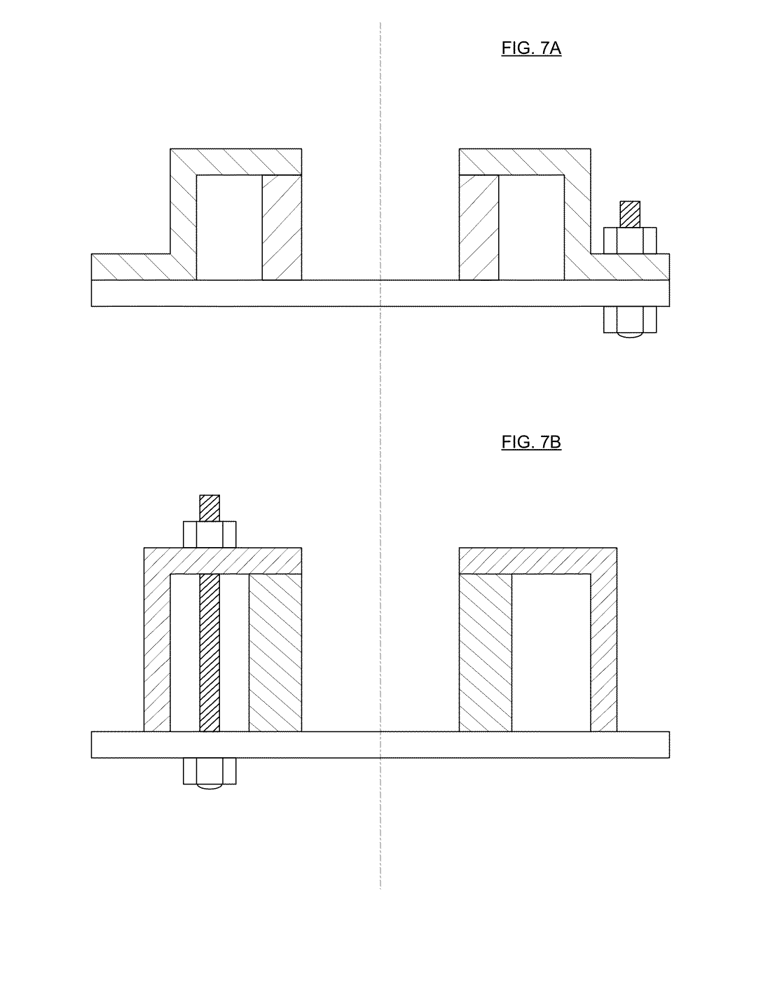

FIGS. 7A-7B illustrate various arrangements in which the split wiper assemblies may be attached to the cleaning plate, in accordance with some embodiments of the present invention. With reference to FIG. 7A, a cleaning plate 710 may have a split wiper assembly 720 attached using a “Z” shaped plate 730. The “Z” shaped plate may comprise a first surface 731 and a second surface 732, connected by a third plate surface which may be substantially perpendicular to the first and second surfaces 731, 732 or may connect at an angle, similar to the letter “Z”. The first surface 731 may contact the split wiper assembly 720, while the second surface 732 may be attached to the cleaning plate 710. For example, as shown in FIG. 7A (which is a non-limiting example), a bolt 750 may be used to connect the “Z” shaped plate 730 to the cleaning plate 710. Accordingly, when the “Z” shaped plate 730 is connected to the cleaning plate 710, the split wiper assembly 720 is sandwiched between, thereby securing the split wiper assembly.

It is contemplated that various other methodologies, systems, and approaches may be used to attach the split wiper assemblies to the cleaning plate. With reference to FIG. 7B, an “L” shaped plate 740 may also be used. The “L” shaped plate 740 may be used to sandwich, and therefore secure, a split wiper assembly 720 to the cleaning plate 710. The “L” shaped plate 740 may comprise a first plate surface 741 and a second plate surface 742. The first plate surface 741 may contact the split wiper assembly, while an edge of the second plate surface 742 may contact the cleaning plate 710. The “L” shaped plate 740 may be secured to the cleaning plate 710 by the use, for example, of a bolt 750 which may connect the first plate surface 741 to the cleaning plate 710.

Note that various other attachment methodologies are contemplated, including but not limited to the use of an interference fit, alternative mechanical connections (e.g. screws, rivets, pins, snap rings etc.), tensile connection (e.g. clamp, spring, bungee, etc.), and/or any other type of connection or attachment.

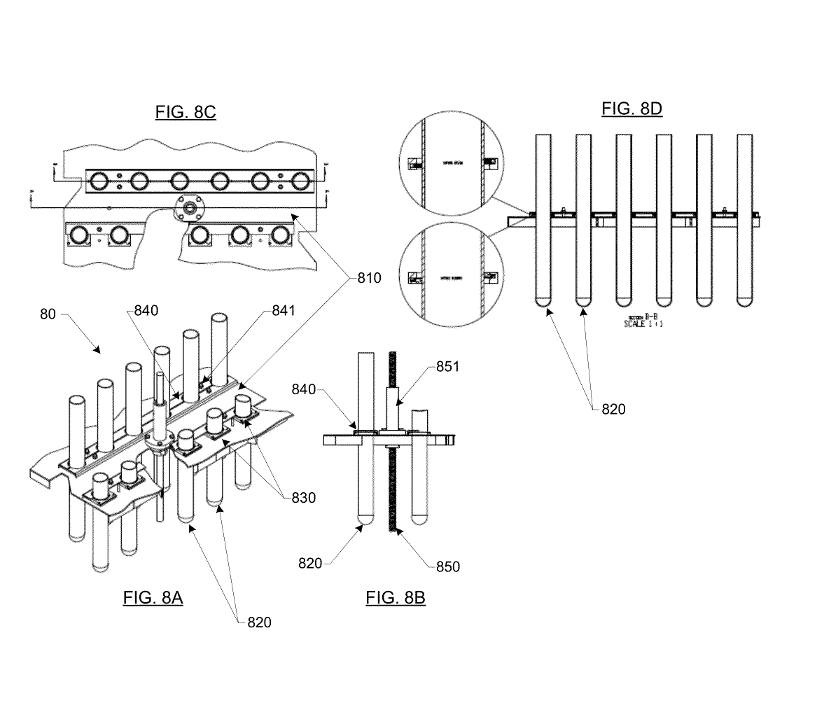

With reference to FIG. 8, an overall UV disinfection module 80 in accordance with some embodiments of the present invention will now be discussed. The UV disinfection module 80 may comprise a cleaning plate 810 with a plurality of holes or orifices aligned with a plurality of UV lamps or jackets 820. The cleaning plate 810 may further comprise, at each hole or orifice, a split wiper assembly 830 (which in turn, as discussed above, may comprise at least two wiper portions and associated housings). Split wiper assemblies 830 may be attached or secured to the cleaning plate 810 by way of attachment plate 840. Attachment plate 840, illustrated in an “L” shaped embodiment, may be in turn attached or secured to the cleaning plate via attachment screws 841. The entire cleaning plate and split wiper assemblies may be moved along the UV lamps or jackets 810 through a movement device 850. As shown, movement device 850 may be a threaded rod that interacts with a nut assembly 851 such that rotating the threaded rod 850 causes the nut assembly—and accordingly the cleaning plate 810—to move laterally along the UV lamps or jackets. However, as noted above, the movement device 850 may comprise for example, a threaded rod or screw, a hydraulic piston, an electric or fluid motor, magnetic, a chain drive or other rotary device, etc. may also be present. The movement device 850 may be disposed such that it can effectuate movement of the cleaning plate 130 along UV lamps or jackets 810 from one header to another.

Note that while the cleaning plate is discussed as moving along the UV lamps or jackets between two headers, it is contemplated that the cleaning plate may be moved beyond the effective portion of the UV lamps such that the cleaning plate may be stored out of the UV light in order to prevent damage or degradation of the wipers or brushes.

Moreover, it is contemplated by the present invention that various devices may be included in the housing and wiper portions to ensure certain, specific, or constant pressure between the wiper portions and the UV lamps or jackets. For example, it is contemplated that a spring may be included in the housing, such that the spring may exert pressure on the wiper portion against the UV lamp or jacket. Accordingly, as the wiper portion wears, minimum friction forces may be maintained. In accordance with some embodiments of the present invention, it is contemplated that after assembly of the wiper portions, a spring, band, bungee, or other type device—for example with elastic properties—may be included around the assembly to exert force on the wiper portions against the UV lamps or jackets. Such device may, for example, pull or push the wiper portions towards the center of the UV lamp or jacket.

It will be understood that the specific embodiments of the present invention shown and described herein are exemplary only. Numerous variations, changes, substitutions and equivalents will now occur to those skilled in the art without departing from the spirit and scope of the invention. Accordingly, it is intended that all subject matter described herein and shown in the accompanying drawings be regarded as illustrative only, and not in a limiting sense, and that the scope of the invention will be solely determined by the appended claims.

1. A cleaning system for a UV disinfection module having a pair of headers with a multiplicity of UV lamps extending therebetween comprising:
a cleaning plate having a multiplicity of openings therein, the openings arranged to substantially coincide with positions of the lamps to permit movement of the plate between the headers;
a split wiper assembly comprising:
a housing comprising a first housing component and a second housing component, the first and second housing components being in contact with each other; and
two or more wiper portions, at least one wiper portion mount in each housing component;
the split wiper assembly connected to the cleaning plate and substantially encircling each opening, sized such that each split wiper assembly has an inner diameter less than the exterior diameter of a corresponding lamp; and
a movement device operatively connected to move the plate between the headers.

2. The system of claim 1, wherein the plurality of wiper portions overlap each other in order fully encircle each opening.

3. The system of claim 1, wherein each wiper portion encircles 180 degrees or more of the openings in the cleaning plate.

4. The system of claim 1, wherein each housing comprises:
a recess that receives the wiper portion; and
a protrusion or lip that keeps the wiper portion in position inside the recess.

5. The system of claim 4, wherein the recess has an inside diameter smaller than an outside diameter of the wiper portion, such that over time friction force between the wiper portion and the lamp is maintained above a minimum value thereby extending the useful lifetime of the wiper portion.

6. The system of claim 1, wherein the split wiper assembly is connected to the cleaning plate to permit lateral movement of the split wiper assembly with respect to the cleaning plate

7. The system of claim 1, wherein each housing is comprised of a material substantially impervious to ultraviolet radiation.

8. The system of claim 7, wherein each housing is comprised of Teflon or plastic.

9. The system of claim 1, wherein each split wiper assembly is held in position by a one or more mounting plates connected to the cleaning plate.

10. The system of claim 9, wherein the mounting plates permit lateral movement of the split wiper assembly along the direction of the UV lamps, but prevent movement of the split wiper assembly axially relative to the cleaning plate.

11. The system of claim 10, wherein the mounting plates comprise “Z” shaped portions.

12. The system of claim 11, wherein the “Z” shaped portions comprise a first and a second plate surface and wherein the first plate surface is attached to the cleaning plate, and wherein the second plate surface is in contact with the split wiper assembly, thereby sandwiching the split wiper assembly between the second plate surface and the cleaning plate.

13. The system of claim 10, wherein the mounting plates comprise “L” shaped portions.

14. The system of claim 13, wherein the “L” shaped portions comprise a first and second surface substantially perpendicular, wherein the first surface is in contact with the split wiper assembly, and wherein an edge of the second surface is in contact with the cleaning plate.

15. The system of claim 1, wherein the wiper portions comprise bristles made of metal, plastic, or natural fibers.

16. The system of claim 1, wherein the wiper portions comprise a hard plastic ring and an elastic or low friction lip seal.

17. The system of claim 1, wherein the movement device comprises a rotatable screw.

18. The system of claim 1, wherein the movement device comprises a pneumatic or hydraulic piston.

19. The system of claim 1, wherein the movement device is selected from the group consisting of: a rotatable screw, a pneumatic piston, a hydraulic piston, a magnetic device, an electric motor, and a hydraulic motor.

20. A cleaning system for a UV disinfection module having a pair of headers with a multiplicity of UV lamps extending therebetween comprising:
a cleaning plate having a multiplicity of openings therein, the openings arranged to substantially coincide with positions of the lamps to permit movement of the plate between the headers;
a split wiper assembly comprising
a housing comprising a first housing component and a second housing component, the first and second housing components being in contact with each other; and
two or more wiper portions, at least one wiper portion mount in each housing component;
the split wiper assembly configured such that the two or more wiper portions overlap each other in order to fully encircle each opening, the split wiper assembly connected to the cleaning plate and substantially encircling each opening, sized such that each split wiper assembly has an inner diameter less than the exterior diameter of a corresponding lamp;
one or more mounting plates, holding the split wiper assembly in position, the one or more mounting plates comprising a first surface and a second surface and wherein the first surface is in contact with the split wiper assembly and the second surface is in contact with the cleaning plate, thereby sandwiching the split wiper assembly between the first surface and the cleaning plate; and
a movement device operatively connected to move the plate between the headers.

21. The system of claim 20, wherein each housing comprises:
a recess that receives the wiper portion; and
a protrusion or lip that keeps the wiper portion in position inside the recess.

22. The system of claim 20, wherein the mounting plates permit lateral movement of the split wiper assembly along the direction of the UV lamps, but prevent movement of the split wiper assembly axially relative to the cleaning plate.

23. A cleaning system for a UV disinfection module having a pair of headers with a multiplicity of UV lamps extending therebetween comprising:
a cleaning plate having a multiplicity of openings therein, the openings arranged to substantially coincide with positions of the lamps to permit movement of the plate between the headers;
a split wiper assembly comprising:
a housing comprising a first housing component and a second housing component, the first and second housing components being in contact with each other; and
two or more wiper portions, at least one wiper portion mount in each housing component;
the split wiper assembly configured such that the two or more wiper portions overlap each other in order to fully encircle each opening, the split wiper assembly connected to the cleaning plate and substantially encircling each opening, sized such that each split wiper assembly has an inner diameter less than the exterior diameter of a corresponding lamp;
one or more mounting plates holding the split wiper assembly in position, the one or more mounting plates comprising a first surface and a second surface and wherein the first surface is in contact with the split wiper assembly and the second surface is in contact with the cleaning plate, thereby sandwiching the split wiper assembly between the first surface and the cleaning plate; and
a rotatable screw operatively connected to move the cleaning plate between the headers.
